(19) United States
(12) Patent Application Publication
(10) Pub. No.: US 2025/0196566 A1
(43) Pub. Date: Jun. 19, 2025

(54) DUCT STRUCTURE FOR AIR COOLING TYPE BATTERY SYSTEM

(71) Applicants: Hyundai Motor Company, Seoul (KR); Kia Corporation, Seoul (KR)

(72) Inventors: JeongHoon Woo, Hwaseong-si (KR); Kyungsang Yu, Hwaseong-si (KR); Jinwon Kim, Hwaseong-si (KR); Jun Young Lim, Hwaseong-si (KR)

(21) Appl. No.: 18/897,102

(22) Filed: Sep. 26, 2024

(30) Foreign Application Priority Data
Dec. 15, 2023 (KR) 10-2023-0183030

(51) Int. Cl. B60H 1/00

(52) U.S. Cl. CPC B60H 1/00278

(57) ABSTRACT

An embodiment duct structure for an air cooling type battery system includes an inlet duct coupled to a module case of a battery module assembly mounted on a vehicle and configured to introduce cooling air into a cooling path between battery cells packaged by the module case to cool the battery cells with the cooling air, wherein the inlet duct is disposed at a lower portion of a front passenger seat of the vehicle, and an outlet duct coupled to the module case and configured to discharge the cooling air heat-exchanged with the battery cells by passing through the battery module assembly, wherein the outlet duct is disposed at a lower portion of a driver seat of the vehicle.

### CROSS-REFERENCE TO RELATED APPLICATIONS

This application claims the benefit of Korean Patent Application No. 10-2023-0183030, filed on Dec. 15, 2023, which application is hereby incorporated herein by reference.

### TECHNICAL FIELD

The present disclosure relates to a battery system for a vehicle.

### BACKGROUND

Recently, the development of eco-friendly cars such as hybrid and electric vehicles has been steadily developing due to an environmental pollution problem and an effort for alternative energy development.

Such eco-friendly vehicles include an electric motor (drive motor) for driving the vehicle and a battery system that supplies power to an electric motor. The battery system is an energy source that drives the electric motor, which can supply high voltage power to electric motors through an inverter.

The battery system has a battery module assembly installed in a battery case. Here, the battery module assembly packages a plurality of battery cells and serves to protect the battery cells from external shock.

The performance of the battery system as described above can depend on a temperature of a surrounding environment and heat generated during the charge and discharge of the battery cells. As a result, the heat generated by the battery cells is cooled in various schemes, and for example, air flows to the battery cells and an air cooling type that cools the battery cells is adopted.

The battery system adopting the air cooling type includes an air supply unit that supplies external air (e.g., cooled air) to the battery cells through an air blower and an air discharge unit that discharges air passing through the battery cells.

Here, the air supply unit includes an inlet duct coupled to a module case of a battery module assembly so as to introduce air into a cooling path between battery cells. Further, the air discharge unit includes an outlet duct that discharges air passing between the battery cells to the outside of the module case of the battery module assembly.

As illustrated in FIGS. 1 and 2, in the case of a hybrid electric vehicle (HEV), a battery 3 is mounted on a lower portion of a first row seat 4, 5 in order to install a battery having a large volume. It is difficult to mount the battery 3 in the vehicle interior, so the battery 3 is mounted on a lower portion 8 of an exterior of a vehicle body, and the inlet duct 1 is in communication with the lower portion of the first row seat 4, 5 in the vehicle interior, and the outlet duct 2 is in communication with the lower portion of a second row seat 6 in a cabin of the vehicle. However, in such a structure, a discharge window is introduced into the cabin, which causes a sense of hot-air and noise. Further, as the outlet duct 2 is located at the second row seat 6, there is a problem in that a foot space for passengers who sit on a second row becomes insufficient.

### SUMMARY

The present disclosure relates to a battery system for a vehicle. Particular embodiments relate to a duct structure for an air cooling type battery system which cools a battery module assembly by an air cooling type using cooling air.

Accordingly, an exemplary embodiment of the present disclosure provides a duct structure for an air cooling type battery system of an HEV in which an inlet duct is configured at a lower portion of a first row passenger seat, and an outlet duct is configured to be extended to a lower portion of a first row driver seat to reduce a sense of hot-air and noise at a second row seat and enhance the merchantability of the second row seat.

An exemplary embodiment of the present disclosure provides a duct structure for an air cooling type battery system configured to cool battery cells of a battery module assembly mounted on a vehicle with cooling air, which includes an inlet duct coupled to the module case to introduce the cooling air into a cooling path between the battery cells packaged by a module case and an outlet duct coupled to the module case to discharge air heat-exchanged with the battery cells by passing through the battery module assembly, in which the inlet duct is provided to be located at a lower portion of a passenger seat of the vehicle and the outlet duct is provided to be located at a lower portion of a driver seat of the vehicle.

The inlet duct may be inserted into the module case and formed in a form of covering an upper portion of the battery module assembly.

The inlet duct may include an inlet introduction portion exposed to the outside of the module case and introduced with the cooling air, an inlet communication portion connected to the inlet introduction portion and extended into the inside of the module case and transmitting the cooling air to the inside of the module case, and an inlet discharge portion connected to the inlet communication portion and discharging the transmitted cooling air to an upper portion of the battery module assembly.

The inlet introduction portion may be water-tightly coupled to the module case by an inlet water-tight member.

The inlet introduction portion may be disposed to protrude to a position higher than a vehicle body on the bottom of the first row passenger seat and to be in communication with the cabin of the vehicle.

The inlet introduction portion may be formed as a net or grill-shaped opening.

The inlet discharge portion may have an edge bolt-coupled and fixed to an upper surface of the module case.

The outlet duct may include an outlet introduction portion connected to the module case and introduced with the heat-exchanged air by passing through the battery module assembly, an outlet communication portion connected to the outlet introduction portion and extended to the outside and transmitting air, and an outlet discharge portion connected to the outlet communication portion and discharging the transmitted air to the outside.

The outlet introduction portion may be water-tightly coupled to the module case by an outlet water-tight member.

The outlet communication portion may be extended in a width direction of the first row driver seat.

The outlet communication portion may be bent to be higher than a horizontal height of the outlet introduction portion and the outlet discharge portion.

The outlet discharge portion may be disposed toward the lower portion of the vehicle at a position lower than the vehicle body on the bottom of the first row driver seat.

The outlet duct may have an edge which is bolt-coupled and fixed to a lower surface of the vehicle body.

A noise reduction pad may be coupled onto an upper surface of the outlet duct coupled to the vehicle body,

According to an exemplary embodiment of the present disclosure, in a duct structure for an air cooling type battery system of an HEV, an inlet duct is configured at a lower portion of a first row passenger seat and an outlet duct is configured to be extended to a lower portion of a first row driver seat to expand a space at a second row seat, reduce a sense of hot-air and noise at a second row seat, and enhance the merchantability of the second row seat.

Further, an inlet of the inlet duct is formed to protrude to a higher position than a vehicle body, an outlet of the outlet duct is formed to face a bottom surface outside the vehicle body, and a water-tight member is applied and coupled to the vehicle body, thereby preventing moisture from being introduced into the duct structure from the cabin of the vehicle.

Further, a path direction of the outlet duct is configured in a bent form to reduce air flow energy, an air discharge position of the outlet duct is disposed at a fire extinguisher mounting position of a driver seat, and a noise reduction pad is attached, thereby reducing a sense of hot-air and noise.

### BRIEF DESCRIPTION OF THE DRAWINGS

FIG. 1 is a perspective view illustrating a duct structure for an air cooling type battery system in the related art.

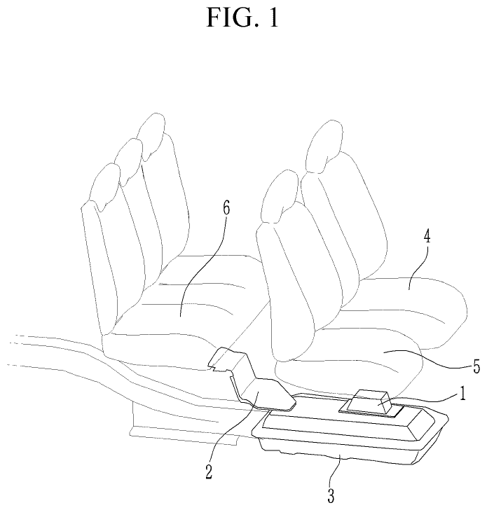

FIG. 2 is a side cross-sectional view illustrating the duct structure for an air cooling type battery system in the related art.

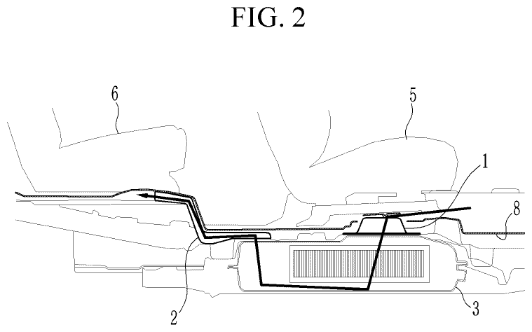

FIG. 3 is a perspective view illustrating a duct structure for an air cooling type battery system according to an exemplary embodiment of the present disclosure.

FIG. 4 is a perspective view illustrating a state in which the duct structure for an air cooling type battery system according to an exemplary embodiment of the present disclosure is mounted on a vehicle.

FIG. 5 is a diagram schematically illustrating a flow of air in the duct structure for an air cooling type battery system according to an exemplary embodiment of the present disclosure.

FIG. 6 is a front view of the duct structure for an air cooling type battery system according to an exemplary embodiment of the present disclosure, which is viewed from a front side of the vehicle.

FIG. 7 is a diagram schematically illustrating an outlet duct and the flow of air in the duct structure for an air cooling type battery system according to an exemplary embodiment of the present disclosure.

FIG. 8 is a cross-sectional view of the duct structure for an air cooling type battery system according to an exemplary embodiment of the present disclosure, which is viewed from a rear side of the vehicle.

FIG. 9 is a perspective view illustrating the outlet duct in the duct structure for an air cooling type battery system according to an exemplary embodiment of the present disclosure.

FIG. 10 is a diagram schematically illustrating the outlet duct in the duct structure for an air cooling type battery system according to an exemplary embodiment of the present disclosure viewed from the bottom.

FIG. 11 is a perspective view illustrating an inlet duct in the duct structure for an air cooling type battery system according to an exemplary embodiment of the present disclosure.

FIG. 12 is a plan view illustrating the inlet duct in the duct structure for an air cooling type battery system according to an exemplary embodiment of the present disclosure viewed from the top of the vehicle.

FIG. 13 is a diagram illustrating the inlet duct in the duct structure for an air cooling type battery system according to an exemplary embodiment of the present disclosure viewed from a rear side of the vehicle.

### DETAILED DESCRIPTION OF ILLUSTRATIVE EMBODIMENTS

Hereinafter, exemplary embodiments of the present disclosure will be described more fully hereinafter with reference to the accompanying drawings so as to be easily implemented by those skilled in the art. Embodiments of the present disclosure may be implemented in various different forms and are not limited to exemplary embodiments described herein.

In addition, in various exemplary embodiments, the components having the same configuration will be described in a first exemplary embodiment using the same reference numeral, and in other exemplary embodiments, only a different component from the first exemplary embodiment will be described.

The drawings are schematic and not illustrated according to a scale. The relative dimensions and ratios of the parts in the drawings are exaggerated or reduced in their sizes for clarity and convenience in the drawing, and any dimensions are just exemplary, not limited. In addition, the same structure, element, or component in two or more drawings is assigned the same reference numeral. When any part of or referred to as being “on”, “over” the other part, which might be directly on or over the other parts or may be a different part involves therebetween.

The exemplary embodiments of the present disclosure specifically represent specific exemplary embodiments of the present disclosure. As a result, various transformations of the diagrams are expected. Therefore, the exemplary embodiments are not limited to a specific form of the illustrated area, for example, they also include a modification of the form of manufacture.

Hereinafter, a duct structure for an air cooling type battery system according to exemplary embodiments of the present disclosure will be described in detail.

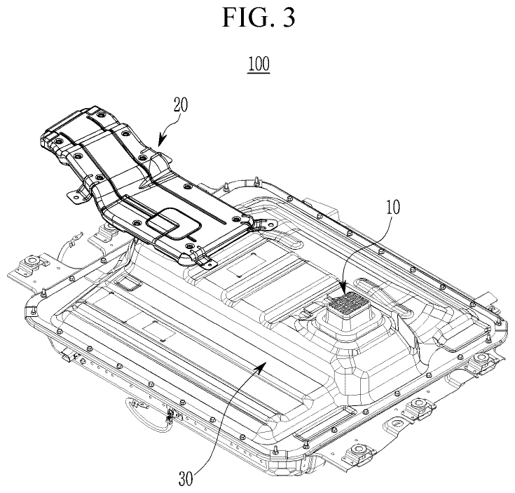

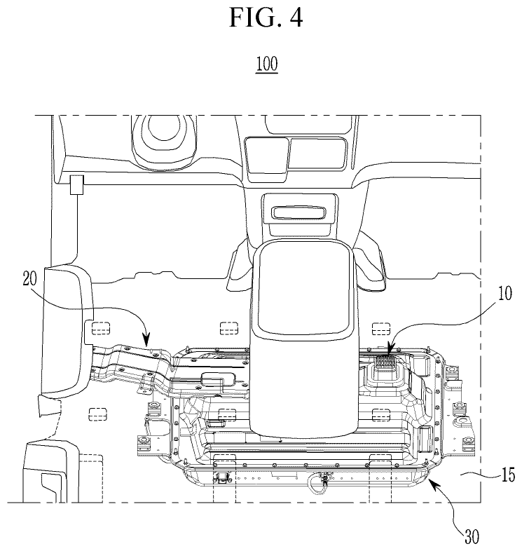

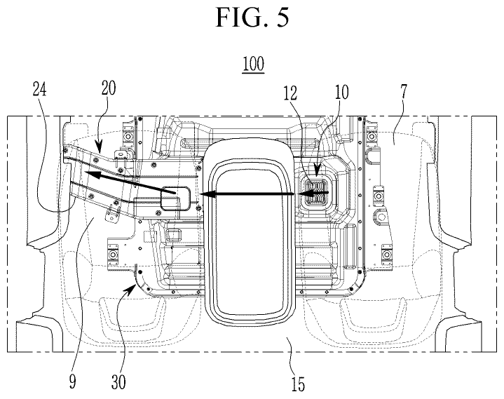

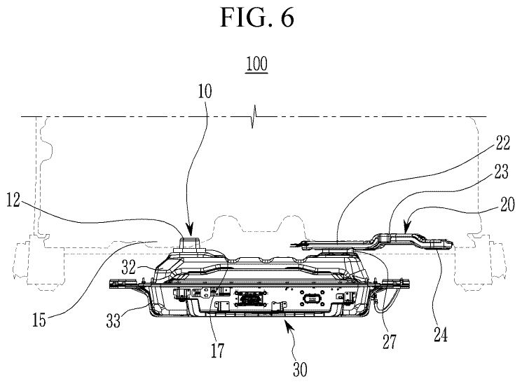

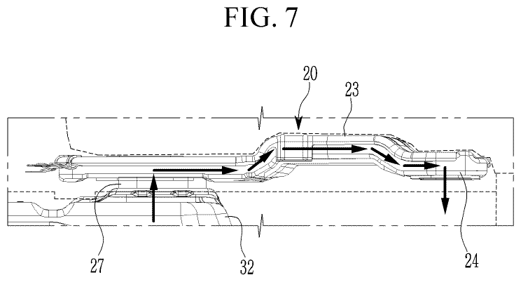

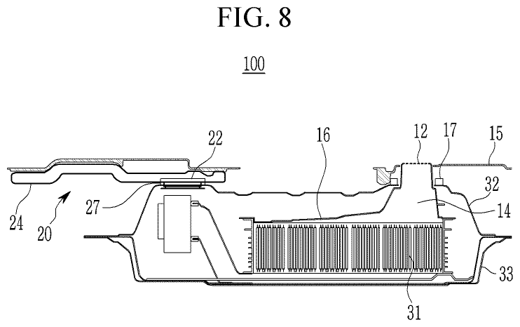

FIG. 3 is a perspective view illustrating a duct structure for an air cooling type battery system according to an exemplary embodiment of the present disclosure, FIG. 4 is a perspective view illustrating a state in which the duct structure for an air cooling type battery system according to an exemplary embodiment of the present disclosure is mounted on a vehicle, FIG. 5 is a diagram schematically illustrating a flow of air in the duct structure for an air cooling type battery system according to an exemplary embodiment of the present disclosure, FIG. 6 is a front view of the duct structure for an air cooling type battery system according to an exemplary embodiment of the present disclosure, which is viewed from a front side of the vehicle, FIG. 7 is a diagram schematically illustrating an outlet duct and the flow of air in the duct structure for an air cooling type battery system according to an exemplary embodiment of the present disclosure, and FIG. 8 is a cross-sectional view of the duct structure for an air cooling type battery system according to an exemplary embodiment of the present disclosure, which is viewed from a rear side of the vehicle.

Referring to FIGS. 3 to 8, a duct structure 100 for an air cooling type battery system according to an exemplary embodiment of the present disclosure may be applied to an electric vehicle which is enabled to be driven with a drive motor as a power source, for example.

However, the duct structure 100 is not limited thereto, and the technical spirit of embodiments of the present disclosure may be applied to eco-friendly vehicles using a drive motor as the power source, such as a hybrid vehicle, a hydrogen-powered vehicle (commonly called a ‘hydrogen electric vehicle’ by those skilled in the art), and a purpose built vehicle (PBV) based on the electric vehicle.

The duct structure 100 for the air cooling type battery system according to an exemplary embodiment of the present disclosure may include a battery module assembly 31 mounted in a battery case and may be applied to an air cooling type battery system which is configured to cool a plurality of battery cells packaged in the battery module assembly 31 with cooling air.

Here, the battery module assembly 31 has a structure in which battery cells are packaged by a module case 30. A cooling path is formed between the battery cells.

The air cooling type battery system may flow cooling air to the cooling path between the battery cells through an air blower (not illustrated), cool the battery cells, and discharge cooling air passing through the battery cells to the outside.

The duct structure 100 for the air cooling type battery system according to an exemplary embodiment of the present disclosure may be constituted by an air supply unit that supplies the cooling air to the cooling path between the battery cells.

In this specification, ‘upper end portion,’ ‘upper portion,’ ‘upper end,’ or ‘upper surface’ of a component represents an end portion, a portion, an end, or a surface of a component at a relatively upper side in a drawing, and ‘lower end portion,’ ‘lower portion,’ ‘lower end,’ or ‘lower surface’ of the component represents an end portion, a portion, an end, or a surface of a component at a relatively lower side in the drawing.

Further, in this specification, an end (e.g., one side end or the other one side end) of the component represents an end of the component in any one direction, and an end portion (e.g., one side end portion or the other one side end portion) of the component represents a predetermined part of the component including an end thereof.

Referring to FIG. 3, the duct structure 100 for an air cooling type battery system according to an exemplary embodiment of the present disclosure includes an inlet duct 10 and an outlet duct 20.

The inlet duct 10 is coupled to the module case 30 to introduce the cooling air into the cooling path between the battery cells packaged by the module case 30.

The outlet duct 20 is coupled to the module case 30 to discharge air heat-exchanged with the battery cells by passing through the battery cells of the battery module assembly 31.

As illustrated in FIGS. 4 and 5, the module case 30 may be located between a driver seat and a passenger seat of the vehicle, and the inlet duct 10 may be located at a lower portion of the passenger seat of the vehicle and the outlet duct 20 may be located at a lower portion of the driver seat of the vehicle, around a position of the module case 30.

Cooling air introduced into the inlet duct 10 at the passenger seat side of the vehicle is introduced into the module case 30 located between the driver seat and the passenger seat. In addition, the cooling air passing through the inside of the module case 30 exchanges heat with the battery cell, and then is discharged to the outside through the outlet duct 20 located at the driver seat side.

Referring to FIGS. 6 to 8, the inlet duct 10 is mounted in a form of being inserted into the module case 30 and is formed to cover an upper portion of the battery module assembly 31. The inlet of the inlet duct 10 is opened toward the passenger seat side of the cabin of the vehicle, and the module case 30 and the outlet duct 20 are disposed at a lower portion of a vehicle body 15.

That is, the cooling air is introduced into the inlet duct 10 at the passenger seat side in the cabin of the vehicle, is transmitted toward the lower portion of the vehicle body 15 from the inlet duct 10, exchanges heat with the battery cell by passing through the module case 30, and then is transmitted to the outlet duct 20 located at the lower portion of the vehicle body 15. Thereafter, the cooling air is discharged toward a ground surface from the lower portion of the vehicle body 15 by passing through the outlet duct 20.

The inlet duct 10 may be constituted by an inlet introduction portion 12, an inlet communication portion 14, and an inlet discharge portion 16.

The inlet introduction portion 12 protrudes to a higher position than the vehicle body 15 on the bottom of the first row passenger seat and is in communication with the cabin of the vehicle.

The inlet communication portion 14 may be connected to the inlet introduction portion 12 and extended to the inside of the module case 30 in a form in which a width gradually increases toward the lower portion.

The inlet discharge portion 16 may be connected to the inlet communication portion 14 and formed to generally cover an upper surface of the battery module assembly 31. Accordingly, the cooling air passing through the inlet communication portion 14 may be generally evenly introduced between the battery cells at an upper portion of the battery module assembly 31 inside the module case 30.

The inlet introduction portion 12 is water-tightly coupled to the module case 30 by an inlet water-tight member 17 to prevent moisture from being introduced into the module case 30.

Meanwhile, the outlet duct 20 may be constituted by an outlet introduction portion 22, an outlet communication portion 23, and an outlet discharge portion 24.

The outlet introduction portion 22 is connected to the module case 30, and heat-exchanged air is introduced into the outlet introduction portion 22 by passing through the battery module assembly 31.

The outlet communication portion 23 is connected to the outlet introduction portion 22 and extended to the outside to be away from the module case 30, and it transmits air. The outlet communication portion 23 may be extended in a width direction of the first row driver seat.

The outlet discharge portion 24 is connected to the outlet communication portion 23 and discharges the transmitted air to the outside.

The outlet introduction portion 22 is water-tightly coupled to the module case 30 by an outlet water-tight member 27 to prevent moisture from being introduced into the module case 30 and prevent the air inside the module case 30 to flow along a path other than the outlet duct 20.

As illustrated in FIG. 7, the outlet communication portion 23 may be formed in a bent form to be higher than a horizontal height of the outlet introduction portion 22 and the outlet discharge portion 24. According to a feature in which the path direction of the outlet duct 20 is configured to be bent, the flow of the air hits a wall in the outlet duct 20, so generation of noise may be reduced by reducing the energy of air flowing.

Further, the outlet communication portion 23 is formed to be bent, and the outlet discharge portion 24 faces a bottom surface of the outside of the vehicle body 15 to prevent moisture from penetrating the duct structure 100 from the cabin of the vehicle.

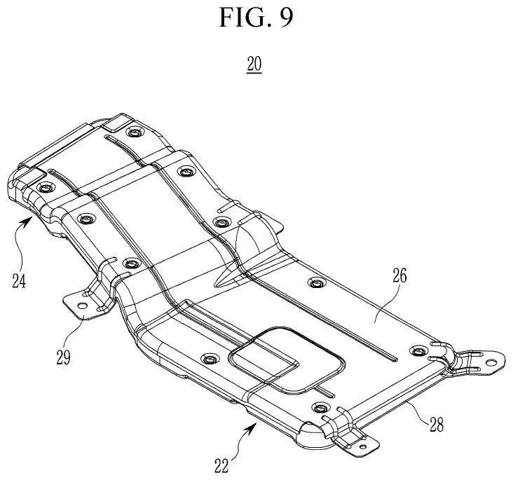

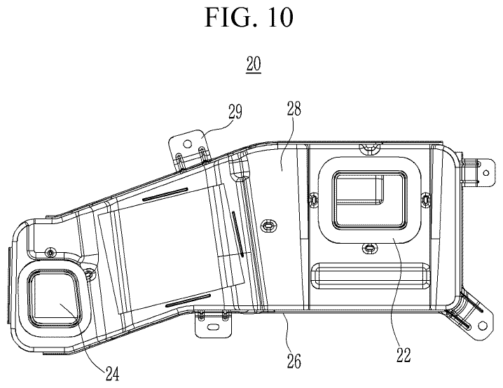

FIG. 9 is a perspective view illustrating the outlet duct in the duct structure for an air cooling type battery system according to an exemplary embodiment of the present disclosure, and FIG. 10 is a diagram illustrating the outlet duct in the duct structure for an air cooling type battery system according to an exemplary embodiment of the present disclosure viewed from the bottom.

Referring to FIGS. 9 and 10, the outlet duct 20 may generally have a bent plate shape. A plurality of mounting brackets 29 may be formed on an edge of the outlet duct 20, and the outlet duct 20 may be coupled to a lower surface of the vehicle body 15 by using a bolt inserted and coupled into the mounting bracket 29.

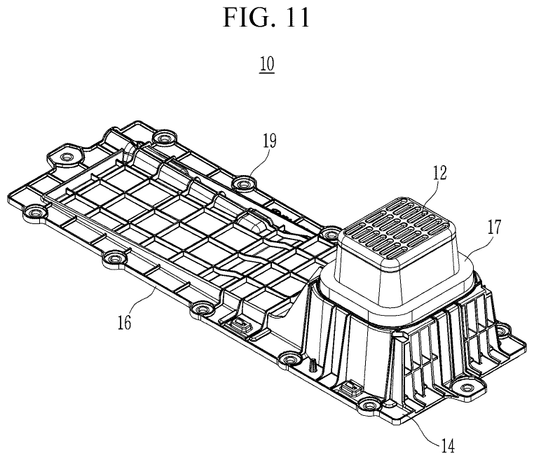

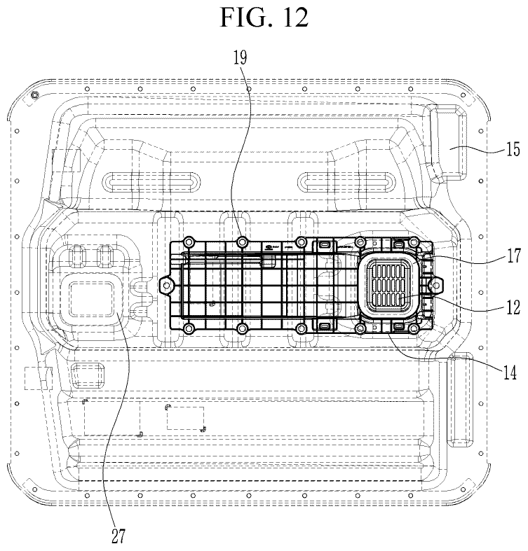

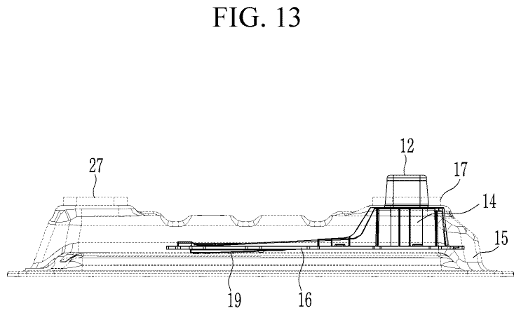

FIG. 11 is a perspective view illustrating an inlet duct in the duct structure for an air cooling type battery system according to an exemplary embodiment of the present disclosure, FIG. 12 is a plan view illustrating the inlet duct in the duct structure for an air cooling type battery system according to an exemplary embodiment of the present disclosure viewed from the top of the vehicle, and FIG. 13 is a diagram illustrating the inlet duct in the duct structure for an air cooling type battery system according to an exemplary embodiment of the present disclosure viewed from a rear side of the vehicle.

Referring to FIGS. 11 to 13, the inlet introduction portion 12 may be formed as a net or grill-shaped opening and located to protrude to a position higher than the vehicle body 15 on the bottom of the first row passenger seat. Such a structure may prevent foreign substances or moisture from penetrating the inside of the duct structure 100 and the module case 30 through the inlet introduction portion 12 from the cabin of the vehicle.

Further, a plurality of mounting holes 19 may be formed on an edge of the inlet discharge portion 16, and the inlet duct 10 may be coupled to the lower surface of the vehicle body 15 by using a bolt inserted and coupled into the mounting hole 19.

Meanwhile, a noise reduction pad 26 may be attached and coupled to a front surface of a body 28 of the outlet duct 20. The noise reduction pad 26 may be made of a material which may reduce noise, vibration, and shock at the same time, and it may be made of an elastic material.

As such, according to an exemplary embodiment of the present disclosure, in a duct structure for an air cooling type battery system of an HEV, an inlet duct is configured at a lower portion of a first row passenger seat, and an outlet duct is configured to be extended to a lower portion of a first row driver seat to expand a space at a second row seat side, reduce a sense of hot-air and noise at a second row seat, and enhance the merchantability of the second row seat.

Further, an inlet of the inlet duct is formed to protrude to a higher position than a vehicle body, an outlet of the outlet duct is formed to face a bottom surface outside the vehicle body, and a water-tight pad is applied and coupled to the vehicle body, thereby preventing moisture from being introduced into the duct structure from the cabin of the vehicle.

Further, a path direction of the outlet duct is configured in a bent form to reduce air flow energy, an air discharge position of the outlet duct is disposed at a fire extinguisher mounting position of a driver seat, and a noise reduction pad is attached, thereby reducing a sense of hot-air and noise.

While embodiments of this invention have been described in connection with what is presently considered to be practical embodiments, it is to be understood that the embodiments are not limited to the disclosed embodiments. On the contrary, they are intended to cover various modifications and equivalent arrangements included within the spirit and scope of the appended claims.

What is claimed is:

1. A duct structure for an air cooling type battery system, the duct structure comprising:
an inlet duct coupled to a module case of a battery module assembly mounted on a vehicle and configured to introduce cooling air into a cooling path between battery cells packaged by the module case to cool the battery cells with the cooling air, wherein the inlet duct is disposed at a lower portion of a front passenger seat of the vehicle; and
an outlet duct coupled to the module case and configured to discharge the cooling air heat-exchanged with the battery cells by passing through the battery module assembly, wherein the outlet duct is disposed at a lower portion of a driver seat of the vehicle.

2. The duct structure of claim 1, wherein the inlet duct is inserted into the module case and covers an upper portion of the battery module assembly.

3. The duct structure of claim 2, wherein the inlet duct comprises:
an inlet introduction portion exposed to an outside of the module case and configured to receive the cooling air;
an inlet communication portion connected to the inlet introduction portion, extending into an inside of the module case, and configured to transmit the cooling air to the inside of the module case; and
an inlet discharge portion connected to the inlet communication portion and configured to discharge the cooling air to the upper portion of the battery module assembly.

4. The duct structure of claim 3, wherein the inlet introduction portion is water-tightly coupled to the module case by an inlet water-tight member.

5. The duct structure of claim 3, wherein the inlet introduction portion is disposed to protrude to a position higher than a vehicle body at a bottom of the front passenger seat and to be in communication with a cabin of the vehicle.

6. The duct structure of claim 3, wherein the inlet introduction portion comprises a net-shaped opening or a grill-shaped opening.

7. The duct structure of claim 3, wherein an edge of the inlet discharge portion is bolt-coupled and fixed to an upper surface of the module case.

8. The duct structure of claim 1, wherein the outlet duct comprises:
an outlet introduction portion connected to the module case and configured to receive the heat-exchanged air after passing through the battery module assembly;
an outlet communication portion connected to the outlet introduction portion, extending to an outside, and configured to transmit the heat-exchanged air; and
an outlet discharge portion connected to the outlet communication portion and configured to discharge the heat-exchanged air to the outside.

9. The duct structure of claim 8, wherein the outlet introduction portion is water-tightly coupled to the module case by an outlet water-tight member.

10. The duct structure of claim 8, wherein the outlet communication portion extends in a width direction of the driver seat.

11. The duct structure of claim 10, wherein the outlet communication portion is bent to be higher than a horizontal height of the outlet introduction portion and the outlet discharge portion.

12. The duct structure of claim 10, wherein the outlet discharge portion is disposed toward a lower portion of the vehicle at a position lower than a vehicle body at a bottom of the driver seat.

13. The duct structure of claim 8, wherein an edge of the outlet duct is bolt-coupled and fixed to a lower surface of a vehicle body of the vehicle.

14. The duct structure of claim 13, further comprising a noise reduction pad coupled to an upper surface of the outlet duct coupled to the vehicle body.

15. A vehicle comprising:
a vehicle body;
a driver's seat and a front passenger seat each mounted in a cabin of the vehicle;
a battery module assembly coupled to the vehicle body and comprising a module case configured to package battery cells;
an inlet duct coupled to the module case and configured to introduce cooling air into a cooling path between the battery cells packaged by the module case to cool the battery cells with the cooling air, wherein the inlet duct is disposed at a lower portion of the front passenger seat; and
an outlet duct coupled to the module case and configured to discharge the cooling air heat-exchanged with the battery cells by passing through the battery module assembly, wherein the outlet duct is disposed at a lower portion of the driver's seat.

16. The vehicle of claim 15, wherein the inlet duct is inserted into the module case and covers an upper portion of the battery module assembly.

17. The vehicle of claim 16, wherein the inlet duct comprises:
an inlet introduction portion exposed to an outside of the module case and configured to receive the cooling air;
an inlet communication portion connected to the inlet introduction portion, extending into an inside of the module case, and configured to transmit the cooling air to the inside of the module case; and
an inlet discharge portion connected to the inlet communication portion and configured to discharge the cooling air to the upper portion of the battery module assembly.

18. The vehicle of claim 17, wherein the inlet introduction portion is disposed to protrude to a position higher than the vehicle body at a bottom of the front passenger seat and to be in communication with the cabin of the vehicle.

19. The vehicle of claim 17, wherein the outlet duct comprises:
an outlet introduction portion connected to the module case and configured to receive the cooling air heat-exchanged by passing through the battery module assembly;
an outlet communication portion connected to the outlet introduction portion, extending to an outside, and configured to transmit the heat-exchanged air; and
an outlet discharge portion connected to the outlet communication portion and configured to discharge the heat-exchanged air to the outside.

20. The vehicle of claim 19, wherein:
the outlet communication portion is bent to be higher than a horizontal height of the outlet introduction portion and the outlet discharge portion; and
the outlet discharge portion is disposed toward a lower portion of the vehicle at a position lower than the vehicle body at a bottom of the driver's seat.
